(19) United States
(12) Patent Application Publication
(10) Pub. No.: US 2020/0201235 A1
(43) Pub. Date: Jun. 25, 2020

(54) IMAGE FORMING APPARATUS AND FOIL SHEET USAGE METHOD

(71) Applicant: KONICA MINOLTA, INC., Tokyo (JP)

(72) Inventor: Shinobu KONNO, Tokyo (JP)

(21) Appl. No.: 16/725,168

(22) Filed: Dec. 23, 2019

(30) Foreign Application Priority Data
Dec. 25, 2018 (JP) 2018-241620

(51) Int. Cl. G03G 15/00

(52) U.S. Cl. CPC G03G 15/6585

(57) ABSTRACT

An image forming apparatus includes an image former, a superposing unit, a fixing unit, and a hardware processor. The image former forms a toner image on a recording medium. The superposing unit superposes (i) a toner-image-side surface of the recording medium and (ii) a coating-layer-side surface of a foil sheet in which a coating layer is formed on a base film. The fixing unit heats and pressurizes the superposed recording medium and foil sheet, thereby transferring the coating layer to a portion where the toner image has been formed on the recording medium. The hardware processor controls the superposing unit such that an existing region of the coating layer and the toner image coincide with one another based on size information indicating a size of the foil sheet, coating layer information indicating the existing region of the coating layer, and toner image information indicating a position of the toner image.

### CROSS-REFERENCE TO RELATED APPLICATIONS

The present invention claims priority under 35 U.S.C. § 119 to Japanese Patent Application No. 2018-241620 filed on Dec. 25, 2018 the entire contents of which are incorporated herein by reference.

### BACKGROUND

### 1. Technological Field

The present invention relates to an image forming apparatus and a foil sheet usage method.

### 2. Description of the Related Art

In recent years, electrophotographic image forming apparatuses have been required to output higher value-added materials, and use a method of: superposing a foil sheet having a coating layer (foil) of gold, silver or the like on a toner image formed on a paper sheet; and heating and pressurizing the superposed foil sheet and paper sheet, thereby transferring the coating layer to a portion where the toner image is formed. Using toner as an adhesive realizes decoration in a color such as a metallic luster color that cannot be expressed with ordinary toner.

For example, there is proposed in JP 2013-195909A a technique used by an image forming apparatus having a fixing unit that fixes an unfixed toner image formed on paper to the paper, the technique of: on the upstream side of the fixing unit, superposing a foil, which adheres not to paper but to toner, on the paper where the unfixed toner image is formed; and sending the superposed foil and paper to the fixing unit, thereby forming a foil image on the paper.

However, decoration with foil sheets uses one foil sheet for one recording medium. Hence, even if one point decoration is desired, it still consumes the whole one foil sheet.

Further, in order to reuse a used foil sheet, it is necessary to grasp which portion of its coating layer (foil) has been used, and also necessary to consider register of the foil sheet with a recording medium. Thus, using foil sheets with no waste is difficult.

### SUMMARY

The present invention has been conceived in view of the above circumstances, and objects of the present invention include reducing cost in decoration with foil sheets.

In order to achieve at least one of the abovementioned objects, according to a first aspect of the present invention, there is provided an image forming apparatus including:

an image former that forms a toner image on a recording medium;

a superposing unit that superposes, on top of one another, (i) of the recording medium, a toner-image-side surface where the toner image is formed and (ii) of a foil sheet in which a coating layer is formed on a base film, a coating-layer-side surface where the coating layer is provided;

a fixing unit that heats and pressurizes the superposed recording medium and foil sheet, thereby transferring the coating layer to a portion where the toner image has been formed on the recording medium; and

a hardware processor that:
obtains coating layer information indicating an existing region of the coating layer in the foil sheet; and
controls the superposing unit such that the existing region of the coating layer in the foil sheet and the toner image formed on the recording medium coincide with one another, based on size information indicating a size of the foil sheet, the coating layer information, and toner image information indicating a position of the toner image on the recording medium.

According to a second aspect of the present invention, there is provided a foil sheet usage method for an image forming apparatus including: an image former that forms a toner image on a recording medium; a superposing unit that superposes, on top of one another, (i) of the recording medium, a toner-image-side surface where the toner image is formed and (ii) of a foil sheet in which a coating layer is formed on a base film, a coating-layer-side surface where the coating layer is provided; and a fixing unit that heats and pressurizes the superposed recording medium and foil sheet, thereby transferring the coating layer to a portion where the toner image has been formed on the recording medium, the method including:

obtaining coating layer information indicating an existing region of the coating layer in the foil sheet; and

controlling the superposing unit such that the existing region of the coating layer in the foil sheet and the toner image formed on the recording medium coincide with one another, based on size information indicating a size of the foil sheet, the coating layer information, and toner image information indicating a position of the toner image on the recording medium.

### BRIEF DESCRIPTION OF THE DRAWINGS

The objects, advantages, and features provided by one or more embodiments of the present invention will become more fully understood from the detailed description given hereinbelow and the appended drawings that are given by way of illustration only, and thus are not intended as a definition of the limits of the present invention.

FIG. 1 schematically shows configuration of an image forming apparatus according to an embodiment(s) of the present invention.

FIG. 2 is a perspective view showing structure of a foil sheet.

FIG. 3A is an illustration to explain configuration of a superposing unit.

FIG. 3B is another illustration to explain the configuration of the superposing unit.

FIG. 4 is a block diagram showing functional configuration of the image forming apparatus.

FIG. 5 shows data structure of a foil sheet management table.

FIG. 6 is an illustration to explain a decoration process.

FIG. 7 is a flowchart showing a foil image forming process that is performed in the image forming apparatus.

FIG. 8 is a flowchart showing a decoration availability determination process.

FIG. 9 is an illustration to explain a reuse example A of a foil sheet.

FIG. 10A shows an example of a paper sheet having a decorating portion constituted of a plurality of points.

FIG. 10B shows an example of a foil sheet used for decorating the paper sheet shown in FIG. 10A.

FIG. 11 is an illustration to explain a reuse example B of a foil sheet.

FIG. 12 is an illustration to explain a reuse example C of foil sheets.

FIG. 13 shows configuration of the superposing unit according to a second modification.

### DETAILED DESCRIPTION OF EMBODIMENTS

Hereinafter, one or more embodiments of the present invention will be described with reference to the drawings. However, the scope of the present invention is not limited to the disclosed embodiments or the illustrated examples.

Hereinafter, one or more embodiments of an image forming apparatus according to the present invention will be described with reference to the drawings.

FIG. 1 schematically shows configuration of an image forming apparatus 100 according to an embodiment(s). The image forming apparatus 100 is an electrophotographic image forming apparatus.

As shown in FIG. 1, the image forming apparatus 100 includes an image former 10, a superposing unit 20, a fixing unit 30, a separator 40, an image reader 50, paper sheet feed trays T1, T2, a paper sheet receiving tray T3, foil sheet feed trays T4, T5, a used foil sheet receiving tray T6, a paper sheet conveyance path R1, a foil sheet conveyance path R2, a paper sheet ejection path R11, a reverse path R12, a non-reverse circulating path R13, a foil sheet ejection path R21, and a foil sheet return path R22.

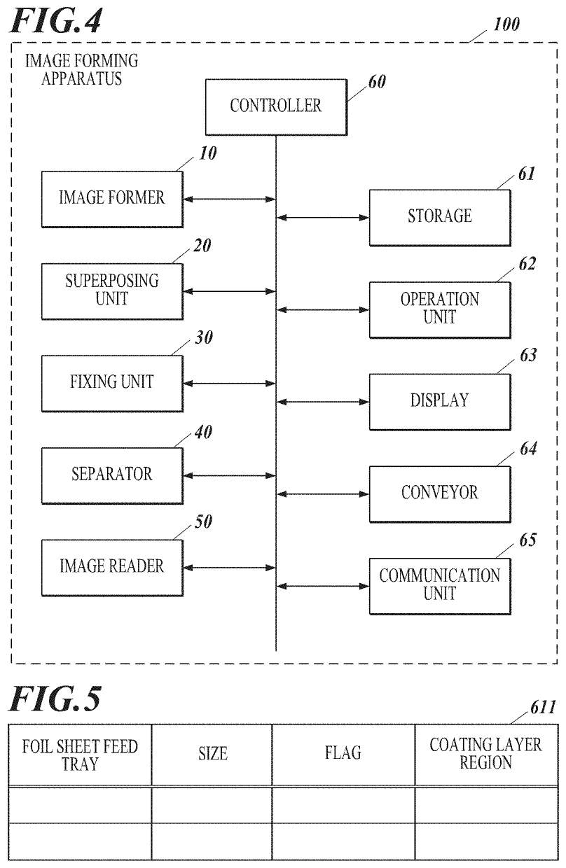

The image former 10 forms toner images on sheets of paper (hereinafter “paper sheets”) P as recording media on the basis of image data of images to be formed. For example, the image former 10 forms a toner image on the basis of image data read by the image reader 50, image data received from an external apparatus, or image data stored in a storage 61 (shown in FIG. 4).

The image former 10 includes a photosensitive drum 11, a charger 12, an exposure unit 13, a developing unit 14, a transfer unit 15, and a cleaner 16.

The charger 12 uniformly charges the photosensitive drum 11.

The exposure unit 13 scans and exposes the photosensitive drum 11 with and to a laser beam on the basis of image data, thereby forming an electrostatic latent image on the photosensitive drum 11.

The developing unit 14 adheres toner to the electrostatic latent image on the photosensitive drum 11 and develops the electrostatic latent image with the toner, thereby forming a toner image on the photosensitive drum 11.

The transfer unit 15 transfers the toner image on the photosensitive drum 11 to a paper sheet P conveyed from the paper sheet feed tray T1 or T2, or along the reverse path R12 or the non-reverse circulating path R13, thereby forming the toner image on the paper sheet P.

The cleaner 16 removes the toner on the photosensitive drum 11 after the toner image is transferred to the paper sheet P, thereby cleaning the photosensitive drum 11.

The superposing unit 20 superposes, on top of one another, (i) a paper sheet P having a toner image formed by the image former 10 and (ii) a foil sheet Q conveyed from the foil sheet feed tray T4 or T5, or along the foil sheet return path R22.

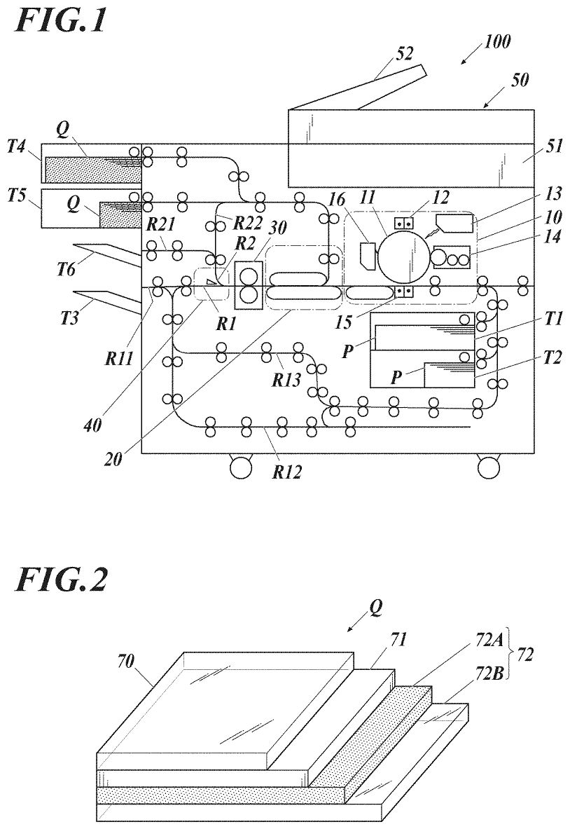

As shown in FIG. 2, a foil sheet Q includes a base film 70, a release layer 71 formed on the base film 70, and a coating layer 72 formed on the release layer 71. The base film 70 is made of resin or the like having optical transparency. The release layer 71 is a layer for easily separating the coating layer 72 from the base film 70. The coating layer 72 is formed by coating a colored layer 72A with a deposition layer 72B. Color of the colored layer 72A is color of a foil image that is added to a paper sheet P by a decoration process. By applying heat and pressure to such a foil sheet Q, its coating layer 72 is transferred to a portion where a toner image is formed on a paper sheet P. In this embodiment, transferring and fixing a coating layer 72 of a foil sheet Q to a paper sheet P is expressed as “decoration” or the like meaning adding a decoration.

The superposing unit 20 superposes, on top of one another, (i) of a paper sheet P, a toner-image-side surface where a toner image is formed and (ii) of a foil sheet Q, a coating-layer-side surface where a coating layer 72 is provided.

In normal image forming (without decoration with foil sheet(s) Q), superposition of a foil sheet Q on a paper sheet P is not performed.

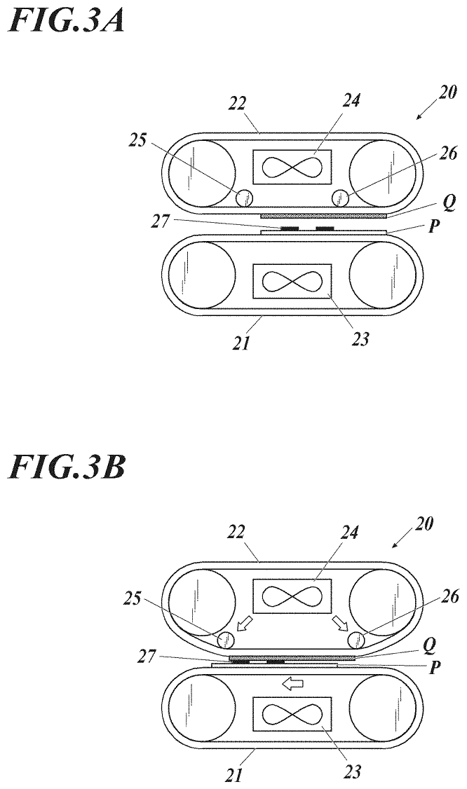

Because the superposing unit 20 superposes a foil sheet Q on a toner image unfixed to a paper sheet P, it is desirable that the superposing unit 20 is configured not to make a foil sheet Q and an unfixed toner image rub against one another. More specifically, as shown in FIG. 3A, the superposing unit 20 includes: an attracting belt 21 that conveys paper sheets P while attracting the paper sheets P; and an attracting belt 22 that conveys foil sheets Q while attracting the foil sheets Q.

The attracting belt 21 is provided with a plurality of air holes formed over the entire surface so as to pass through the front and back surfaces, and a suction fan 23 attracts paper sheets P to the upper side of the attracting belt 21 through the air holes by suction. The attracting belt 21 extends over a plurality of rollers, and rotates by following rotational drive of at least one of the rollers. The attracting belt 21 conveys paper sheets P by its own rotation while attracting the paper sheets P.

Similarly, the attracting belt 22 is provided with a plurality of air holes formed over the entire surface so as to pass through the front and back surfaces, and a suction fan 24 attracts foil sheets Q to the lower side of the attracting belt 22 through the air holes by suction. The attracting belt 22 extends over a plurality of rollers, and rotates by following rotational drive of at least one of the rollers. The attracting belt 22 conveys foil sheets Q by its own rotation while attracting the foil sheets Q.

The attracting belt 22 is provided with movable rollers 25, 26 on its inner side. When a foil sheet Q and a paper sheet P are conveyed to and reach a position where the coating layer 72 of the foil sheet Q and a toner image 27 on the paper sheet P match one another in position, the movable rollers 25, 26 are moved outward as shown in FIG. 3B, so that the attracting belt 22 protrudes downward, and the foil sheet Q, which is attracted to the attracting belt 22, is brought into close contact with the paper sheet P. Thus, the superposing unit 20 superposes the coating-layer-side surface, where the coating layer 72 is provided, of the foil sheet Q on the toner-image-side surface, where the toner image 27 is formed, of the paper sheet P.

For example, a sensor detects the top of the paper sheet P in the conveying direction, and on the basis of the distance from the top of the paper sheet P to the toner image 27 and the position of the coating layer 72 of the foil sheet Q, the attracting belts 21, 22 are operated to superpose the foil sheet Q on the paper sheet P such that the coating layer 72 of the foil sheet Q and the toner image 27 on the paper sheet P coincide with one another, and to convey the superposed foil sheet Q and paper sheet P to the fixing unit 30.

The superposing unit 20, which is configured not to make a foil sheet Q and an unfixed toner image rub against one another, is not limited to using air suction as described above, and may use electrostatic attraction or the like.

The fixing unit 30 includes a pair of rollers constituted of a heating roller and a pressure roller. Paper sheets P are exposed to heat and pressure by passing through a nip part formed by the pair of rollers.

In normal image forming, the fixing unit 30 heats and pressurizes a toner image formed on a paper sheet P by the image former 10, thereby fixing the toner image to the paper sheet P.

In decoration, the fixing unit 30 heats and pressurizes a paper sheet P and a foil sheet Q in a state in which the paper sheet P and the foil sheet Q are superposed, thereby transferring the coating layer 72 to a portion where a toner image is formed on the paper sheet P.

The separator 40 separates, from one another, a paper sheet P and a foil sheet Q after the fixing unit 30 transfers the coating layer 72 of the foil sheet Q to the paper sheet P. The separator 40 conveys the separated paper sheet P to the paper sheet conveyance path R1 and the separated foil sheet Q to the foil sheet conveyance path R2.

The paper sheet conveyance path R1 leads to the paper sheet ejection path R11, the reverse path R12, and the non-reverse circulating path R13. The paper sheet ejection path R11 is a path along which paper sheets P are ejected to the paper sheet receiving tray T3. The reverse path R12 is a path along which paper sheets P are reversed so that images can be formed on both sides of the paper sheets P, and is connected to the upstream side of the image former 10 in the conveying direction of paper sheets P. The non-reverse circulating path R13 is a path along which paper sheets P are led to the image former 10 and the superposing unit 20 without being reversed, and is connected to the upstream side of the image former 10 in the conveying direction of paper sheets P. The non-reverse circulating path R13 is also a path along which paper sheets P separated from foil sheets Q by the separator 40 are conveyed to the superposing unit 20 again.

The foil sheet conveyance path R2 leads to the foil sheet ejection path R21 and the foil sheet return path R22. The foil sheet ejection path R21 is a path along which foil sheets Q are ejected to the used foil sheet receiving tray T6. The foil sheet return path R22 is a path for foil sheets Q to be reused without being reversed, and is connected to the upstream side of the superposing unit 20. The foil sheet return path R22 is also a path along which foil sheets Q separated from paper sheets P by the separator 40 are conveyed to the superposing unit 20 again.

The image reader 50 includes a scanner 51 and an automatic document feeder (ADF) 52, and generates image data by reading images of documents or the like.

For example, the image reader 50 reads a foil sheet Q set on the scanner 51 and generates image data thereof. The image reader 50 reads a foil sheet Q, so that coating layer information indicating an existing region of the coating layer 72 in the foil sheet Q is obtained. For example, in image data of a foil sheet Q generated by the image reader 50, the existing region of the coating layer 72 in the foil sheet Q is represented by black pixels, and a peeled-off region (transparent portion) of the coating layer 72 in the foil sheet Q is represented by white pixels.

The paper sheet feed trays T1, T2 store paper sheets P by paper type and size.

To the paper sheet receiving tray T3, image-formed paper sheets P and decorated paper sheets P are ejected.

On the foil sheet feed trays T4, T5, foil sheets Q are placed. On the foil sheet feed trays T4, T5, used foil sheets Q, which have been used earlier, may also be placed.

To the used foil sheet receiving tray T6, used foil sheets Q are ejected.

FIG. 4 is a block diagram showing functional configuration of the image forming apparatus 100.

As shown in FIG. 4, the image forming apparatus 100 includes the image former 10, the superposing unit 20, the fixing unit 30, the separator 40, the image reader 50, a controller 60 (hardware processor), the storage 61, an operation unit 62, a display 63, a conveyor 64, and a communication unit 65. Description of the functional units or the like described above is not repeated.

The controller 60 includes a central processing unit (CPU), a read only memory (ROM), and a random access memory (RAM). The CPU reads various process programs stored in the ROM, loads the read programs to the RAM, and centrally controls operations of the components of the image forming apparatus 100 in accordance with the loaded programs.

The storage 61 includes a hard disk and/or a flash memory, and stores various data. For example, the storage 61 stores a foil sheet management table 611.

FIG. 5 shows data structure of the foil sheet management table 611. In the foil sheet management table 611 stores, for each foil sheet Q, data on a foil sheet feed tray, a size, a flag, and a coating layer region are associated with one another and stored.

In the “Foil Sheet Feed Tray” field, identification information of the foil sheet feed tray T4 or T5 where a foil sheet Q is placed is stored.

In the “Size” field, information indicating dimensions of a foil sheet Q in its conveying direction and width direction are stored.

In the “Flag” field, a flag (1: used, 0: unused) indicating whether or not a foil sheet Q is a used foil sheet Q is stored.

In the “Coating Layer Region” field, the coating layer information indicating the existing region of the coating layer 72 (coating layer region) in a foil sheet Q is stored if the flag for the foil sheet Q is “1”.

If two or more foil sheets Q are placed on the foil sheet feed tray T4 or T5, the above information is further associated with information indicating where in the placed foil sheets Q each foil sheet Q is present (e.g. 1^{st}, 2^{nd}, . . . or n^{th} from the top).

If a foil sheet Q registered in the foil sheet management table 611 is used up and is no longer present on the foil sheet feed tray T4 or T5, the record of the foil sheet Q is deleted from the foil sheet management table 611.

The operation unit 62 includes a touchscreen formed so as to cover the display screen of the display 63, number buttons, a start button, and various other operational buttons, and outputs operation signals based on user operations to the controller 60.

The display 63 is constituted of a liquid crystal display (LCD), and displays various screens in accordance with instructions of display signals input from the controller 60.

The conveyor 64 includes conveying rollers for conveying paper sheets P and foil sheets Q, and conveys paper sheets P and foil sheets Q in the image forming apparatus 100.

The communication unit 65 sends and receives data to and from external apparatuses connected via a predetermined cable(s). The communication unit 65 also sends and receives data to and from external apparatuses connected via a communication network, such as a local area network (LAN).

The controller 60 controls the conveyor 64 to feed and convey paper sheets P from the paper sheet feed trays T1, T2 to the image former 10, and controls the image former 10 to form (transfer) toner images on (to) the paper sheets P The controller 60 may control the conveyor 64 to convey the paper sheets P to the image former 10 again via the reverse path R12 or the non-reverse circulating path R13.

The controller 60 controls the conveyor 64 to convey the toner-image-formed paper sheets P to the superposing unit 20.

The controller 60 also controls the conveyor 64 to feed and convey foil sheets Q from the foil sheet feed trays T4, T5 to the superposing unit 20. The controller 60 may control the conveyor 64 to convey the foil sheets Q to the superposing unit 20 again via the foil sheet return path R22.

The controller 60 controls the superposing unit 20, on the basis of size information indicating the size of a foil sheet Q, the coating layer information indicating the existing region of the coating layer 72 in the foil sheet Q, and toner image information indicating the position of a toner image formed on a paper sheet P, such that the coating layer 72 existing in the foil sheet Q and the toner image formed on the paper sheet P coincide with one another. More specifically, the controller 60 grasps the existing region of the coating layer 72 (coating layer region) of the foil sheet Q from the size information and the coating layer information on the foil sheet Q, collates the coating layer region in the foil sheet Q with a portion where the toner image is formed (decorating portion) on the paper sheet P, and adjusts conveyance timings and conveyance speeds of the foil sheet Q and the paper sheet P such that the decorating portion of the paper sheet P can be decorated with the coating layer region of the foil sheet Q.

The controller 60 controls the conveyor 64 to convey the foil sheet Q and the paper sheet P superposed by the superposing unit 20.

The fixing unit 30 makes the toner component viscous by heat, and consequently makes a portion of the coating layer 72, the portion contacting the toner (toner image), peel off from the release layer 71 of the foil sheet Q, thereby transferring (the portion of) the coating layer 72 to the paper sheet P. The paper sheet P, to which the coating layer 72 has been transferred, is cooled after passing through the fixing unit 30. Thus, the fixing unit 30 fixes (adheres) the coating layer 72 to the paper sheet P.

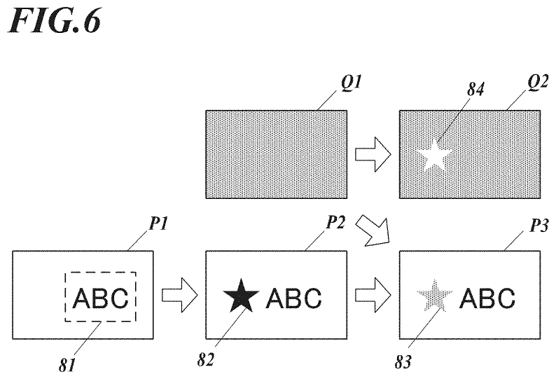

The decoration process (decoration) will be described with reference to FIG. 6. Hereinafter, a paper sheet P and a foil sheet Q in each step may be represented by the reference signs “P” and “Q” with numerals, respectively.

A paper sheet P1 represents a paper sheet P before decorated, and has a character string 81 “ABC” printed in advance by offset printing or the like.

A paper sheet P2 represents a paper sheet P obtained by the image former 10 forming a star-shaped toner image 82 on the paper sheet P1. The superposing unit 20 superposes a foil sheet Q1 having a gold coating layer 72 on the paper sheet P2. The superposed foil sheet Q1 and paper sheet P2 pass through the fixing unit 30, so that a paper sheet P3 to which a gold foil image 83 has been transferred and a foil sheet Q2 from which a star-shaped portion 84 of the coating layer 72 has peeled off are obtained. In the foil sheet Q2, the star-shaped portion 84 is transparent.

It is possible to form characters, such as “ABC”, on a paper sheet P with an appropriate image forming method, such as an electrophotographic method, after decorating the paper sheet P with a foil sheet Q.

The controller 60 determines whether or not a portion where a toner image is to be formed on a paper sheet P can be covered with the coating layer 72 existing in a foil sheet Q. More specifically, the controller 60 determines whether or not a portion where a toner image is to be formed on a paper sheet P can be covered with the coating layer 72 existing in a foil sheet Q that is placed on the foil sheet feed tray T4 or T5 or present on a path (e.g. foil sheet return path R22) along which foil sheets Q can be conveyed to the superposing unit 20. That is, the controller 60 determines whether or not the coating layer 72 of a targeted foil sheet Q still has an area required for decoration.

The controller 60 performs control to convey a foil sheet Q to the superposing unit 20, the foil sheet Q determined as its coating layer 72 being able to cover a portion where a toner image is to be formed on a paper sheet P.

If the coating layer 72 of a foil sheet Q still has an area required for the next decoration, after causing the separator 40 to separate the foil sheet Q from a paper sheet P superposed thereon for reuse, the controller 60 performs control to convey the foil sheet Q to the superposing unit 20 again via the foil sheet return path R22. On the other hand, if the coating layer 72 of a foil sheet Q does not have an area required for the next decoration, the controller 60 performs control to eject the foil sheet Q to the used foil sheet receiving tray T6.

The controller 60 determines whether or not a portion where a toner image(s) is to be formed on a paper sheet P can be covered with the coating layers 72 existing in respective foil sheets Q. More specifically, the controller 60 determines whether or not a portion where a toner image(s) is to be formed on a paper sheet P can be covered with the coating layers 72 existing in respective foil sheets Q that are each placed on the foil sheet feed tray T4 or T5 or present on the path (e.g. foil sheet return path R22) along which foil sheets Q can be conveyed to the superposing unit 20.

The controller 60 performs control to convey foil sheets Q to the superposing unit 20, the foil sheets Q determined as their coating layers 72 being able to cover a portion where a toner image(s) is to be formed on a paper sheet P.

The controller 60 obtains the coating layer information indicating the existing region of the coating layer 72 in a foil sheet Q on the basis of image data of a toner image that has been formed earlier on a paper sheet P, the toner image corresponding to a portion to which the coating layer 72 of the foil sheet Q has been transferred earlier on the paper sheet P (i.e. on the basis of image data of a toner image that has been decorated with the foil sheet Q (coating layer 72) earlier). Because the controller 60 recognizes the size of a paper sheet P and the shape of the decorating portion to be decorated, the controller 60 can determine which portion of the coating layer 72 is transferred from its foil sheet Q to the paper sheet P and which portion of the coating layer 72 remains in the foil sheet Q.

Next, operation of the image forming apparatus 100 will be described.

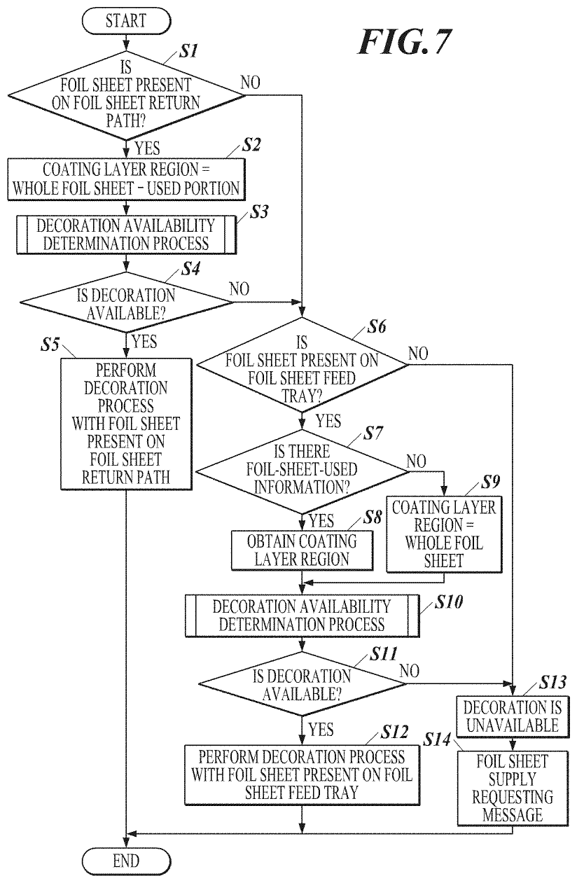

FIG. 7 is a flowchart showing a foil image forming process that is performed in the image forming apparatus 100. This process is realized by software processing that is performed by the CPU of the controller 60 in cooperation with a program(s) stored in the ROM.

First, the controller 60 determines whether or not a foil sheet Q is present on the foil sheet return path R22 (Step S1). For example, the foil sheet return path R22 is provided with a sensor that detects presence or absence of foil sheets Q. In this case, the controller 60 determines on the basis of a detection result obtained by the sensor whether or not a foil sheet Q is present on the foil sheet return path R22. Alternatively, if a foil sheet Q has been used earlier, information indicating that the foil sheet Q has been conveyed to the foil sheet return path R22 may be stored at the time of use. In this case, the controller 60 determines on the basis of this information that a foil sheet Q is present on the foil sheet return path R22.

If a foil sheet Q is present on the foil sheet return path R22 (Step S1; YES), the controller 60 obtains, about the foil sheet Q present on the foil sheet return path R22, the coating layer region by excluding its used portion from the whole foil sheet Q (region of the coating layer 72 before used for any decoration) (Step S2). If decoration has just finished first time, the coating layer region is obtained by excluding a region/portion of the coating layer 72 used for the first time of decoration from the whole foil sheet Q, whereas if decoration has been performed multiple times, the coating layer region is obtained by excluding regions/portions of the coating layer 72 used for the multiple times of decoration from the whole foil sheet Q. Each used portion of a foil sheet Q (coating layer 72) corresponds to a portion where a foil image has been formed on a paper sheet P, namely that has been decorated with the foil sheet Q, and hence is determined on the basis of image data of a toner image that has been formed on the paper sheet P.

Next, the controller 60 performs a decoration availability determination process (Step S3).

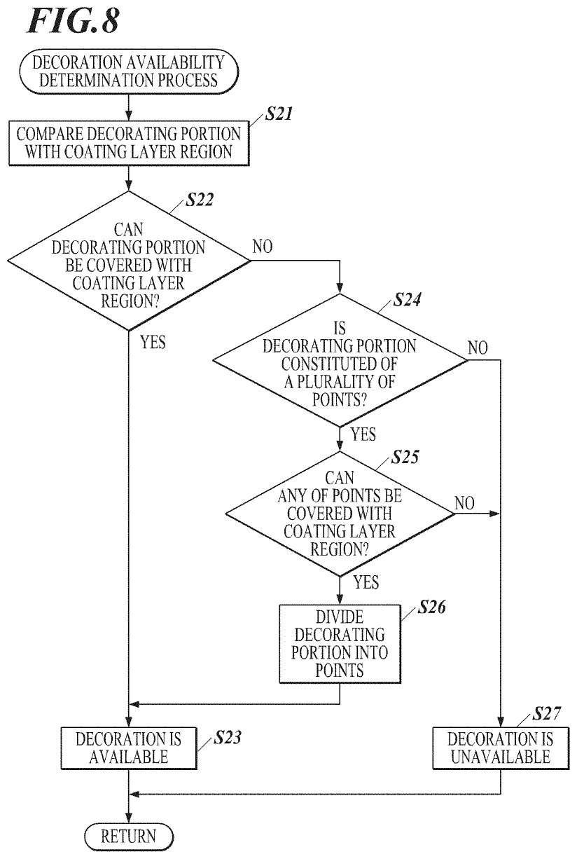

Hereinafter, the decoration availability determination process will be described with reference to FIG. 8.

The controller 60 compares a portion where a toner image is to be formed (decorating portion) on a paper sheet P with the coating layer region of the foil sheet Q (Step S21), and determines whether or not the decorating portion of the paper sheet P can be covered with the coating layer region of the foil sheet Q (Step S22).

If the decorating portion of the paper sheet P can be covered with the coating layer region of the foil sheet Q (Step S22; YES), the controller 60 determines that decoration is available (Step S23).

In Step S22, if the decorating portion of the paper sheet P cannot be covered with the coating layer region of the foil sheet Q (Step S22; NO), the controller 60 determines whether or not the decorating portion is constituted of a plurality of points (Step S24).

If the decorating portion is constituted of a plurality of points (Step S24; YES), the controller 60 determines whether or not any of the points can be covered with the coating layer region of the foil sheet Q (Step S25).

If (at least) one of the points can be covered with the coating layer region of the foil sheet Q (Step S25; YES), the controller 60 divides the decorating portion into the points (Step S26), and determines that decoration is available for the point, which is determined in Step S25 as a point that can be covered with the coating layer region (Step S23). In this case, the controller 60 (i) controls the image former 10 to form a toner image, by setting, among the points, the determined point as a current decorating portion, (ii) performs control to decorate the toner image with the coating layer region, and (iii) performs control to lead the paper sheet P to the non-reverse circulating path R13 so as to decorate the remaining point(s) next time (and the following time(s)).

In Step S24, if the decorating portion is not constituted of a plurality of points (Step S24; NO), or in Step S25, if none of the points can be covered with the coating layer region of the foil sheet Q (Step S25; NO), the controller 60 determines that decoration is unavailable (Step S27).

After Step S23 or Step S27, the decoration availability determination process ends.

Referring back to FIG. 7, after Step S3, if decoration is available (Step S4; YES), the controller 60 performs the decoration process with the foil sheet Q present on the foil sheet return path R22 (Step S5). More specifically, the controller 60 controls the image former 10 to form the toner image on the paper sheet P on the basis of its image data, which corresponds to a foil image (i.e. a portion to which the coating layer 72 is transferred). Then, the controller 60 controls the superposing unit 20 to superpose the coating-layer-side surface, where the coating layer 72 is provided, of the foil sheet Q on the toner-image-side surface, where the toner image is formed, of the paper sheet P, and controls the fixing unit 30 to heat and pressurize the superposed foil sheet Q and paper sheet P, thereby transferring the coating layer 72 to the portion where the toner image is formed on the paper sheet P. At the time, the controller 60 controls the superposing unit 20 on the basis of the size information indicating the size of the foil sheet Q, the coating layer information indicating the existing region of the coating layer 72 in the foil sheet Q, and the toner image information indicating the position of the toner image on the paper sheet P such that the coating layer 72 existing in the foil sheet Q and the toner image formed on the paper sheet P coincide with one another.

In Step S1, if no foil sheet Q is present on the foil sheet return path R22 (Step S1; NO), or in Step S4, if decoration is unavailable (Step S4; NO), the controller 60 determines whether or not a foil sheet Q is present on the foil sheet feed tray T4 or T5 (Step S6). For example, the foil sheet feed trays T4, T5 are provided with sensors that detect presence or absence of foil sheets Q. In this case, the controller 60 determines on the basis of detection results obtained by the sensors whether or not a foil sheet Q is present on the foil sheet feed tray T4 or T5. Alternatively, the controller 60 may determine whether or not a foil sheet Q is registered in the foil sheet management table 611 stored in the storage 61.

If a foil sheets Q is present on the foil sheet feed tray T4 or T5 (Step S6; YES), the controller 60 determines whether or not there is foil-sheet-used information on the foil sheet Q (Step S7). More specifically, the controller 60 refers to the foil sheet management table 611 stored in the storage 61, and determines whether or not the flag for the foil sheet Q is “1”.

If there is foil-sheet-used information on the foil sheet Q (Step S7; YES), the controller 60 obtains the coating layer region of the foil sheet Q from the foil sheet management table 611 (Step S8).

Data in the “Coating Layer Region” field in the foil sheet management table 611 is information registered when a user places a used foil sheet Q on the foil sheet feed tray T4 or T5. At the time, the controller 60 causes the image reader 50 to read the used foil sheet Q, obtains information indicating the coating layer region from the generated image data, and stores the obtained information in the foil sheet management table 611. Alternatively, the user may manually input, with the operation unit 62, information on the existing region of the coating layer 72 in the foil sheet Q, for example, information indicating that the first half (top side) or the second half (bottom side) of the coating layer 72 in the conveying direction of foil sheets Q remains in the foil sheet Q.

In Step S7, if there is no foil-sheet-used information on the foil sheet Q (Step S7; NO), the controller 60 obtains the size of the foil sheet Q from the foil sheet management table 611, and obtains the whole foil sheet Q as the coating layer region (Step S9).

After Step S8 or Step S9, the controller 60 performs the decoration availability determination process (shown in FIG. 8) (Step S10).

After Step S10, if decoration is available (Step S11; YES), the controller 60 performs the decoration process with the foil sheet Q present on the foil sheet feed tray T4 or T5 (Step S12). Details of the decoration process are the same/similar as/to those performed in Step S5.

In Step S6, if no foil sheet Q is present on the foil sheet feed tray T4 or T5 (Step S6; NO), or in Step S11, if decoration is not available (Step S11; NO), the controller 60 determines that decoration is unavailable (Step S13), and causes the display 63 to display a foil sheet supply requesting message that urges the user to supply foil sheets Q (Step S14).

After Step S5, Step S12 or Step S14, the foil image forming process ends.

Next, specific examples of the decoration process involving reuse of foil sheets Q will be described.

FIG. 6 shows the case where a foil sheet Q and a paper sheet P are of the same size, and the foil sheet Q and the paper sheet P are superposed to coincide with (i.e. match) one another. However, for saving foil sheets Q, it is preferable that a relative position of a foil sheet Q and a paper sheet P be shifted by a required dimension of the coating layer 72 in the conveying direction each time a paper sheet P is decorated with the foil sheet Q.

### REUSE EXAMPLE A

A reuse example A is an example in which one foil sheet Q is used multiple times. The foil sheet Q may be a foil sheet Q that is conveyed again to the superposing unit 20 via the foil sheet return path R22, or a used foil sheet Q that is placed again on the foil sheet feed tray T4 or T5 to be fed again.

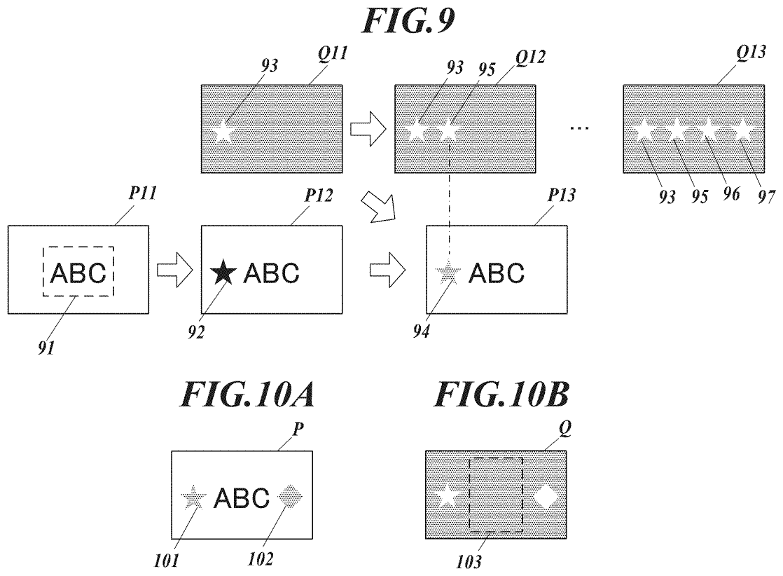

As shown in FIG. 9, on a paper sheet P11 on which a character string 91 “ABC” is printed in advance by offset printing or the like, the image former 10 forms a star-shaped toner image 92, like a paper sheet P12.

A foil sheet Q11 has been used once, and consequently a star-shaped portion 93 of the coating layer 72 has peeled off. The superposing unit 20 superposes the foil sheet Q11 on the paper sheet P12 such that the star-shaped portion 93 and the toner image 92 do not coincide with one another by shifting the foil sheet Q11 and the paper sheet P12 from one another by about one star shape in the conveying direction. The superposed foil sheet Q11 and paper sheet P12 pass through the fixing unit 30, so that a paper sheet P13 to which a foil image 94 has been transferred and a foil sheet Q12 from which a star-shaped portion 95 (in addition to the star-shaped portion 93) of the coating layer 72 has peeled off are obtained. By repeating the same process, a foil sheet Q13 from which star-shaped portions 93, 95, 96, 97 of the coating layer 72 have peeled off is obtained.

FIG. 9 shows the case where the relative position of a foil sheet Q and each paper sheet P is shifted in the conveying direction only. However, paper sheets P may also be shifted in a direction perpendicular to the paper sheet conveying direction, namely the paper sheet width direction, in order to further reduce waste of the coating layers 72 of foil sheets Q.

### REUSE EXAMPLE B

The decorating portion is not limited to one point, and may be constituted of a plurality of points.

For example, as shown in FIG. 10A, foil images 101, 102 may be formed on a paper sheet P at points that are some distance away from one another. A foil sheet Q used for decorating the paper sheet P has a narrow future-usable region 103 as shown in FIG. 10B. Thus, it is difficult, in this case, to perform the decoration process while efficiently reusing foil sheets Q.

To deal with such a case, the decoration process is performed multiple times on the same surface of a paper sheet P. This minimizes waste of the coating layers 72 of foil sheets Q. In order to perform the decoration process multiple times on the same surface of a paper sheet P, the non-reverse circulating path R13, which is for conveying toner-image-formed paper sheets P to the superposing unit 20 again without reversing the paper sheets P, is used.

A reuse example B is an example in which the coating layer 72 of a foil sheet Q is used from an end with no waste.

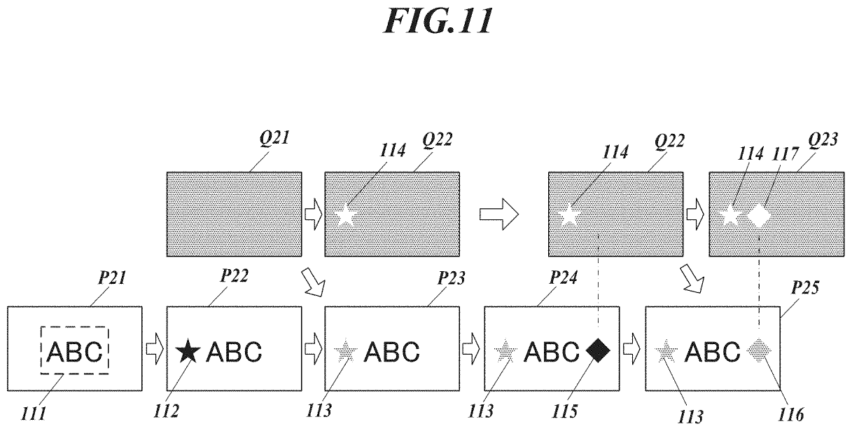

As shown in FIG. 11, on a paper sheet P21, a character string 111 “ABC” is printed in advance by offset printing or the like.

A paper sheet P22 represents a paper sheet P obtained by the image former 10 forming a star-shaped toner image 112 on the paper sheet P21. The superposing unit 20 superposes a foil sheet Q21 on the paper sheet P22. The superposed foil sheet Q21 and paper sheet P22 pass through the fixing unit 30, so that a paper sheet P23 to which a foil image 113 has been transferred and a foil sheet Q22 from which a star-shaped portion 114 of the coating layer 72 has peeled off are obtained. The foil sheet Q22 is conveyed to the foil sheet return path R22.

Next, the paper sheet P23 is conveyed to the image former 10 via the non-reverse circulating path R13, and the image former 10 forms a rhombic toner image 115, like a paper sheet P24. The superposing unit 20 superposes the foil sheet Q22 on the paper sheet P24. The superposed foil sheet Q22 and paper sheet P24 pass through the fixing unit 30, so that a paper sheet P25 to which a foil image 116 has been transferred and a foil sheet Q23 from which a rhombic portion 117 of the coating layer 72 has peeled off are obtained. The star-shaped portion 114 and the rhombic portion 117 have been made to be located as close as possible but not to overlap with one another. This leaves a wide future-usable region of the coating layer 72 and hence minimizes waste of the coating layer 72.

### REUSE EXAMPLE C

A reuse example C is an example in which a plurality of foil sheets Q is used for decorating the same surface of a paper sheet P. Even if a foil sheet Q has a small existing region of the coating layer 72 or has a size smaller than a paper sheet P, using a plurality of foil sheets Q and making a paper sheet P pass through the superposing unit 20 multiple times realizes desired decoration and minimizes waste of foil sheets Q.

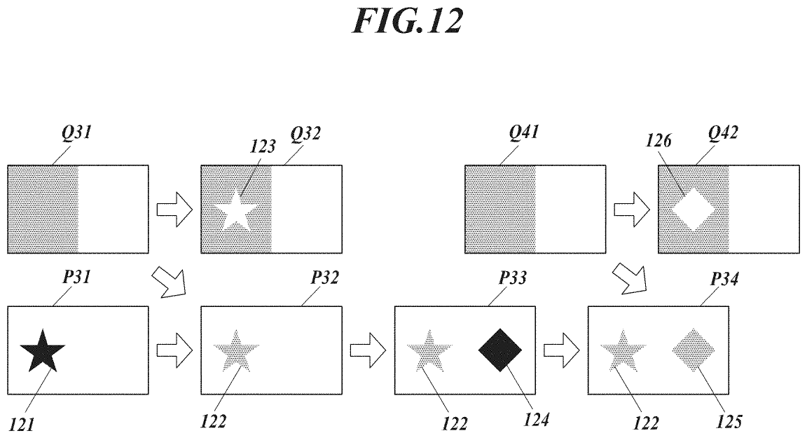

The reuse example C will be described with reference to FIG. 12. In the reuse example C, reuse foil sheets Q31, Q41 each having the coating layer 72 a half of which has been used are used for decorating the same surface of a paper sheet P. The reuse foil sheets Q31, Q41 are, for example, used foil sheets Q placed on the foil sheet feed tray T4 or T5 for reuse.

First, the image former 10 forms a star-shaped toner image 121 on a paper sheet P31. The superposing unit 20 superposes the reuse foil sheet Q31, which has a half of the coating layer 72, on the paper sheet P31. The superposed foil sheet Q31 and paper sheet P31 pass through the fixing unit 30, so that a paper sheet P32 to which a foil image 122 has been transferred and a used foil sheet Q32 from which a star-shaped portion 123 of the coating layer 72 has peeled off are obtained.

Next, the image former 10 forms a rhombic toner image 124, like a paper sheet P33. The superposing unit 20 superposes the reuse foil sheet Q41, which has a half of the coating layer 72, on the paper sheet P33. The superposed foil sheet Q41 and paper sheet P33 pass through the fixing unit 30, so that a paper sheet P34 to which a foil image 125 has been transferred and a used foil sheet Q42 from which a rhombic portion 126 of the coating layer 72 has peeled off are obtained.

FIG. 12 shows the case where the reuse foil sheets Q31, Q41 each having a small remaining region of the coating layer 72 are used. However, using a plurality of small foil sheets Q realizes decoration of a large paper sheet P in the same/similar manner.

If foil images having the same shape are formed (i.e. if the same foil image is formed multiple times), decoration can be performed as follows: keep used foil sheets Q for reuse; read the used foil sheets Q with the image reader 50 before reusing them and store, in the storage 61, the coating layer regions of the respective used foil sheets Q associated with their sheet numbers; place the used foil sheets Q on the foil sheet feed tray T4 or T5 in order of the sheet numbers; and perform decoration on the basis of the information stored in the storage 61.

As described above, according to this embodiment, a foil sheet Q and a paper sheet P are superposed on top of one another such that the existing region of the coating layer 72 in the foil sheet Q and a toner image formed on the paper sheet P coincide with one another. This makes use of the coating layer 72 with no waste in reusing the foil sheet Q, and hence can reduce cost in decoration with foil sheets Q.

Further, the image reader 50 reads the foil sheet Q, so that the coating layer information indicating the existing region of the coating layer 72 in the foil sheet Q is obtained. This makes it easy to grasp where in a used foil sheet Q the coating layer 72 remains.

The coating layer information may be obtained from image data of a toner image that has been formed earlier on the (or another) paper sheet P, the toner image corresponding to a portion (decorating portion) to which the coating layer 72 of in the foil sheet Q has been transferred earlier on the (or another) paper sheet P.

Further, it is determined whether or not a portion (decorating portion) where the toner image is to be formed on the paper sheet P can be covered with the coating layer 72 existing in the foil sheet Q, and the foil sheet Q determined as its coating layer 72 being able to cover the decorating portion on the paper sheet P is conveyed to the superposing unit 20.

Further, if the decorating portion on the paper sheet P is constituted of a plurality of points, the decorating portion may be covered with a plurality of foil sheets Q. More specifically, in order to cover the points constituting the decorating portion with the coating layers 72 existing in the respective foil sheets Q, the decorating portion is divided into the points, and the foil sheets Q determined as their coating layers 72 being able to cover the points constituting the decorating portion are conveyed to the superposing unit 20.

Further, the image forming apparatus 100 has the foil sheet return path R22 along which the foil sheet Q separated from the paper sheet P by the separator 40 is conveyed to the superposing unit 20 again. This makes it possible to use a foil sheet Q multiple times.

Further, the image forming apparatus 100 has the non-reverse circulating path R13 along which the paper sheet P separated from the foil sheet Q by the separator 40 is conveyed to the superposing unit 20 again. This makes it possible to decorate the same surface of a paper sheet P by taking multiple times.

If a foil sheet Q and a paper sheet P to be superposed are of the same size, the foil sheet Q and the paper sheet P are less likely to cause slippage by being conveyed with their ends aligned. However, if ends of a foil sheet Q and a paper sheet P are not aligned in order that the coating layer region of the foil sheet Q and the decorating portion (toner image) of the paper sheet P coincide with one another, the foil sheet Q and the paper sheet P may cause slippage in a state in which the foil sheet Q and the paper sheet P are in contact with one another owing to the difference in their timings of entering the fixing unit 30 or how the foil sheet Q and the paper sheet P are superposed. In particular, if a foil sheet Q is superposed on an unfixed toner image, the slippage fuzzes the unfixed toner image, which may result in poor image forming (of a foil image) on the decorating portion.

To deal with this, the image forming apparatus 10 may be configured such that not only unfixed toner images but also fixed toner images can be decorated with foil sheets Q superposed thereon. A fixed toner image can be decorated as follows: convey a toner-image-fixed paper sheet P to the superposing unit 20 by making use of the non-reverse circulating path R13, and decorate the toner image fixed to the paper sheet P with a foil sheet Q. This can prevent foil images from being fuzzy. A method of fixing and decorating an unfixed toner image at the same time and a method of fixing a toner image and then decorating the toner image may be performed selectively.

The non-reverse circulating path R13 may be connected to the upstream side or the downstream side of the image former 10 as long as it is connected to the upstream side of the superposing unit 20.

The non-reverse circulating path R13 connected to the upstream side of the image former 10 has an advantage that toner images can be formed on paper sheets P that have passed through the fixing unit 30 earlier.

If the non-reverse circulating path R13 is connected to the downstream side of the image former 10, and it is desired to decorate a plurality of points, the image former 10 may first form a plurality of toner images on a paper sheet P (at the plurality of points), and the toner images (points) may be decorated by taking multiple times.

### First Modification

Next, a first modification of the above embodiment will be described. In the first modification, the components same as those of the image forming apparatus 100 described in the above embodiment are designated by the same reference signs as the above, and illustration and description thereof are not repeated.

In the first modification, a toner image is formed on a decorated paper sheet P.

The image former 10 forms a toner image on a portion to which the coating layer 72 of a foil sheet Q has been transferred on a paper sheet P.

If used foil sheets Q are placed on the foil sheet feed tray T4 or T5 to reuse the foil sheets Q, it is difficult to prepare many kinds of foil sheets Q. To deal with this, instead of preparing gold foil sheets Q and silver foil sheets Q, which are often used for decoration, only silver foil sheets Q may be prepared. If it is desired to decorate a paper sheet P in gold, after decorated with a silver foil sheet Q, the paper sheet P is conveyed again to the image former 10 via the non-reverse circulating path R13, and a yellow toner is put on the silver foil (coating layer). This shows an effect equivalent to that of decoration with a gold foil sheet Q.

According to the first modification, a toner image is formed on a portion (foil image) to which the coating layer 72 of a foil sheet Q has been transferred on a paper sheet P. This enables decoration in a color expressed by a mixed color of the color of the colored layer 72A of the coating layer 72 and the color of toner. In addition to the advantage that foil sheets Q do not need to be prepared in many colors, the above has an effect of further facilitating reuse of foil sheets Q, for example, by preparing only silver foil sheets Q, which leads to cost reduction.

If color toners are used, the image forming apparatus 100 includes not the monochrome image former 10 shown in FIG. 1 but a full-color image former.

### Second Modification

Next, a second modification of the above embodiment will be described. In the second modification, the components same as those of the image forming apparatus 100 described in the above embodiment are designated by the same reference signs as the above, and illustration and description thereof are not repeated.

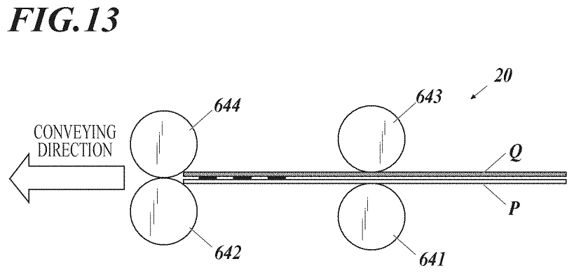

In the above embodiment, the superposing unit 20 superposes an unfixed toner image formed on a paper sheet P and a foil sheet Q on top of one another, whereas in the second modification, the superposing unit 20 superposes a fixed toner image formed on a paper sheet P and a foil sheet Q on top of one another. Unlike unfixed toner images, which become fuzzy if they rub against foil sheets Q, fixed toner images do not become fuzzy. Hence, with a simple configuration shown in FIG. 13, the superposing unit 20 can superpose a paper sheet P and a foil sheet Q on top of one another while registering (aligning) the paper sheet P and the foil sheet Q in the conveying direction

As shown in FIG. 13, the superposing unit 20 in the second modification includes paper sheet conveying rollers 641, 642 and foil sheet conveying rollers 643, 644. The paper sheet conveying roller 642 and the foil sheet conveying roller 644 on the downstream side in the paper sheet conveying direction (foil sheet conveying direction) are used as register rollers. A paper sheet P and a foil sheet Q are bumped against the paper sheet conveying roller 642 and the foil sheet conveying roller 644 so that their ends (tops) are aligned (registered), and the paper sheet conveying roller 642 and the foil sheet conveying roller 644 are rotated at the same time to convey the paper sheet P and the foil sheet Q to the fixing unit 30.

Now, let's suppose that a paper sheet P has passed through the fixing unit 30 earlier with a toner image formed, and has been conveyed again to the superposing unit 20 via the non-reverse circulating path R13.

The controller 60 obtains a distance from the top of the paper sheet P to the toner image formed on the paper sheet P on the basis of the size of the paper sheet P and the toner image information indicating the position of the toner image on the paper sheet P.

If a foil sheet Q is reused, the controller 60 obtains a distance from the top of the foil sheet Q to a portion where the coating layer 72 remains in the foil sheet Q.

On the basis of the obtained distances about the paper sheet P and the foil sheet Q, the controller 60 causes the conveying rollers (641, 642, 643, 644) to convey the paper sheet P and the foil sheet Q to the fixing unit 30 in a state in which the toner image on the paper sheet P and the coating layer 72 remaining in the foil sheet Q coincide with one another. The controller 60 causes the conveying rollers (641, 642 or 643, 644) for the paper sheet P or the foil sheet Q, whichever needs to be conveyed more according to the obtained distances, to operate more by the difference between the distances.

According to the second modification, a foil sheet Q is superposed on a toner image fixed to a paper sheet P, whereby the coating layer 72 existing in the foil sheet Q is transferred to the paper sheet P. As compared with a case where a foil sheet Q is superposed on a toner image unfixed to a paper sheet P, the above can prevent foil images from being fuzzy.

The above embodiment, modifications and so forth are examples of an image forming apparatus of the present invention and not intended to limit the present invention. The detailed configurations/components and operations of the components constituting the image forming apparatus can also be appropriately modified within the scope of the present invention.

Although some embodiments or the like of the present invention have been described and illustrated in detail, the disclosed embodiments or the like are made for purposes of not limitation but illustration and example only. The scope of the present invention should be interpreted by terms of the appended claims.

The entire disclosure of Japanese Patent Application No. 2018-241620 filed Dec. 25, 2018 is incorporated herein by reference in its entirety.

What is claimed is:

1. An image forming apparatus comprising:
an image former that forms a toner image on a recording medium;
a superposing unit that superposes, on top of one another, (i) of the recording medium, a toner-image-side surface where the toner image is formed and (ii) of a foil sheet in which a coating layer is formed on a base film, a coating-layer-side surface where the coating layer is provided;
a fixing unit that heats and pressurizes the superposed recording medium and foil sheet, thereby transferring the coating layer to a portion where the toner image has been formed on the recording medium; and
a hardware processor that:
obtains coating layer information indicating an existing region of the coating layer in the foil sheet; and
controls the superposing unit such that the existing region of the coating layer in the foil sheet and the toner image formed on the recording medium coincide with one another, based on size information indicating a size of the foil sheet, the coating layer information, and toner image information indicating a position of the toner image on the recording medium.

2. The image forming apparatus according to claim 1, wherein the hardware processor determines whether or not the portion where the toner image is to be formed on the recording medium can be covered with the coating layer existing in the foil sheet.

3. The image forming apparatus according to claim 2, wherein the hardware processor:
determines whether or not the portion where the toner image is to be formed on the recording medium can be covered with the coating layer existing in the foil sheet that is on (i) a foil sheet feed tray or (ii) a path along which the foil sheet can be conveyed to the superposing unit; and
in response to determining that the portion can be covered with the coating layer existing in the foil sheet, performs control to convey the foil sheet to the superposing unit.

4. The image forming apparatus according to claim 1, wherein
the foil sheet includes foil sheets including coating layers, and
the hardware processor determines whether or not the portion where the toner image is to be formed on the recording medium can be covered with the coating layers existing in the respective foil sheets.

5. The image forming apparatus according to claim 4, wherein the hardware processor:
determines whether or not the portion where the toner image is to be formed on the recording medium can be covered with the coating layers existing in the respective foil sheets that are each on (i) a foil sheet feed tray or (ii) a path along which the foil sheets can be conveyed to the superposing unit; and
in response to determining that the portion can be covered with the coating layers existing in the respective foil sheets, performs control to convey the foil sheets to the superposing unit.

6. The image forming apparatus according to claim 1, further comprising:
a separator that separates the recording medium and the foil sheet from one another after the fixing unit transfers the coating layer from the foil sheet to the recording sheet; and
a path along which the separated foil sheet is conveyed to the superposing unit again.

7. The image forming apparatus according to claim 1, further comprising:
a separator that separates the recording medium and the foil sheet from one another after the fixing unit transfers the coating layer from the foil sheet to the recording sheet; and
a path along which the separated recording medium is conveyed to the superposing unit again.

8. The image forming apparatus according to claim 7, wherein
the path along which the recording medium is conveyed to the superposing unit again is connected to an upstream side of the image former in a conveying direction of the recording medium, and
the image former forms a toner image on the portion to which the coating layer has been transferred on the recording medium.

9. The image forming apparatus according to claim 1, further comprising an image reader, wherein
the hardware processor obtains the coating layer information from the image reader reading the foil sheet.

10. The image forming apparatus according to claim 1, wherein the hardware processor obtains the coating layer information based on image data of a toner image that has been formed earlier on the recording medium or another recording medium, the toner image corresponding to a portion to which the coating layer has been transferred earlier on the recording medium or the another recording medium.

11. A foil sheet usage method for an image forming apparatus including: an image former that forms a toner image on a recording medium; a superposing unit that superposes, on top of one another, (i) of the recording medium, a toner-image-side surface where the toner image is formed and (ii) of a foil sheet in which a coating layer is formed on a base film, a coating-layer-side surface where the coating layer is provided; and a fixing unit that heats and pressurizes the superposed recording medium and foil sheet, thereby transferring the coating layer to a portion where the toner image has been formed on the recording medium, the method comprising:
obtaining coating layer information indicating an existing region of the coating layer in the foil sheet; and
controlling the superposing unit such that the existing region of the coating layer in the foil sheet and the toner image formed on the recording medium coincide with one another, based on size information indicating a size of the foil sheet, the coating layer information, and toner image information indicating a position of the toner image on the recording medium.
